(19) United States
(12) Patent Application Publication
(10) Pub. No.: US 2010/0238366 A1
(43) Pub. Date: Sep. 23, 2010

(54) Method of Displaying a Depth Fused Display

(76) Inventors: Chao-Song Chang, Taipei City (TW); Cheng-Chung Hu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/505,547

(22) Filed: Jul. 20, 2009

(30) Foreign Application Priority Data
Mar. 17, 2009 (TW) 098108663

(51) Int. Cl. G02F 1/1335; G09G 5/00

(52) U.S. Cl. 349/15; 345/6; 345/5

(57) ABSTRACT

The present invention discloses a method to display a depth fused display. The method includes the following steps. First, a depth fused display that includes a first panel and a second panel is provided. The first panel can display a first image, the second panel can display a second image, and the two panels are disposed in parallel and opposite to each other. Then, the view angle signal of an observer is detected, and the relative position of the first image and the second image is adjusted according to the view angle signal of the observer such that the observer may perceive a stereoscopic image.

### BACKGROUND OF THE INVENTION

1. Field of the Invention

The present invention relates to a method of displaying a depth fused display, more particularly, to a displaying method that is not affected when the relative position between the observer and the depth fused display is changed.

2. Description of the Prior Art

With the development of science and technology, the present display mode that displays only 2D images is no longer able to meet the needs of the users. The research units are committed to the development of three-dimensional display technology, hoping to make the observer perceive a three-dimensional stereoscopic vision under a two-dimensional display environment. Present stereoscopic display technology includes: the parallax barrier technology and the depth fused technology that uses multi panels.

The parallax barrier technology is provided by a certain way, to present different images to the left eye and the right eye individually so that the observer can sense a stereoscopic image. The depth fused display that uses multi panels is to display two similar images with different brightness on two separate display panels. When the two images are superimposed, a continuous depth sense can be performed. For instance, when the image on the front panel is brighter than the image on the back panel, the observer can sense a fused image near the front panel.

Please refer to FIG. 1, illustrating a schematic diagram of a conventional depth fused display. As shown in FIG. 1, conventional depth fused display 1 includes a first panel 11 and a second panel 13. The first panel 11 and the second panel 13 are disposed substantially parallel to each other and the first panel 11 is closer to an observer 16. The first panel 11 can display a first image 12 and the second panel 13 can display a second image 14. The first image 12 and the second image 14 are the identical (e.g. the ball image shown in FIG. 1), but the brightness of the first image 12 and the second image 14 are different, thereby producing a depth fused image. For example, the brightness of the first image 12 at position A on the first panel 11 is less than the brightness of the second image 14 at the corresponding position A′ on the second panel 13. Therefore, the observer 16 will perceive a stereoscopic image 15 near the second panel 13 by superimposing the low-brightness first image 12 and the high-brightness second image 14. If the first image 12 and the second image 14 have the same brightness at position B and B′, the superimposed stereoscopic image 15 will be perceived in middle of the first panel 11 and the second panel 13. Similarly, if the brightness of the first image 12 is greater than the brightness of the second image 14 at position C and C′, the stereoscopic image 15 will be perceived near the first panel 11. As a result, according to three examples at position A, B and C, the fused stereoscopic image 15 is obtained by displaying similar images on the first panel 11 and the second panel 13. And the stereoscopic image 15 can be obtained at any depth by allocating the brightness ratio of the first image 12 and the second image 14, rendering the observer 16 perceive three-dimensional sense of different depth.

However, when the view angle of the observer 16 is in a slight deviation, two separate images will be obtained. Please refer to FIG. 2, illustrating a schematic diagram of displaying a depth fused display in a vertical manner and in an oblique manner. As shown in FIG. 2, when the observer 16 is at the position P1 of vertical observation, the first image 12 and the second image 14 displayed by the first panel 11 and the second panel 13 stands in a line with the eye of the observer 16. The observer 16 can therefore obtain a depth fused stereoscopic image superimposed by the first image 12 and the second image 14. However, when the observer 16 is at the position P2 of oblique observation, the first image 12 and the second image 14 are not superimposed. The observer 16 will obtain two separate images rather than a three-dimensional image. Accordingly, in order to obtain a fused stereoscopic image, the observer should view the images vertically so as to superimpose the images precisely. However, the stereoscopic image is no longer obtained when the observer changes his position or moves his view angle, quite limiting the location of the observer.

### SUMMARY OF THE INVENTION

It is one object of the present invention to provide a method of displaying a depth fused display to overcome the feature that the observer fails to obtain a stereoscopic image when obliquely displaying or position changing, allowing the observer to have a greater degree of freedom.

According to the claimed invention, a method of displaying a depth fused display is provided. The method includes the following steps. First, a depth fused display that includes a first panel and a second panel is provided. The first panel can display a first image, the second panel can display a second image, and the two panels are disposed in parallel and opposite to each other. Then, the view angle signal of an observer is detected, and the relative position of the first image and the second image is adjusted according to the view angle signal of the observer such that the observer may perceive a stereoscopic image.

The present invention provides a tracer to detect the view angle of the observer, thereby adjusting the relative position of the first panel and the second panel with respect to the view angle. Even if the view angle of the observer is changed, the depth fused display may response immediately to allow the observer obtain a fused image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a conventional depth fused display.

FIG. 2 illustrates a schematic diagram of displaying a depth fused display in a vertical manner and in an oblique manner.

FIG. 3 illustrates a block diagram of the depth fused display in the present invention.

FIG. 4 illustrates a flow chart diagram of the method of displaying a depth fused display in the present invention.

FIG. 5 to FIG. 7 illustrate schematic diagrams of adjusting the first image and/or the second image to obtain a superimposed image in the present invention.

FIG. 8 to FIG. 10 illustrate the schematic diagrams of adjusting the first panel and/or the second panel to obtain a fused stereoscopic image while maintaining a vertical distance between the first panel and the second panel.

FIG. 11 illustrates a schematic diagram of adjusting a vertical distance between the first panel and the second panel to obtain a fused stereoscopic image in the present invention.

FIG. 12 illustrates a schematic diagram of the depth fused display including two LCD panels in the present invention.

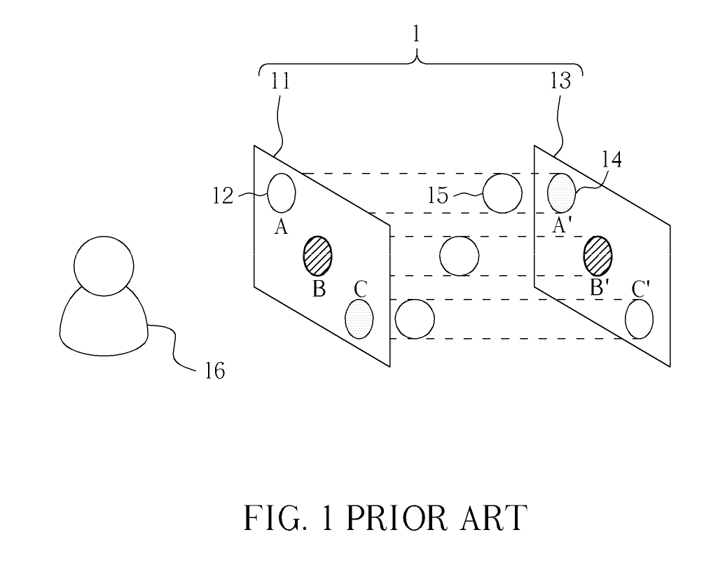

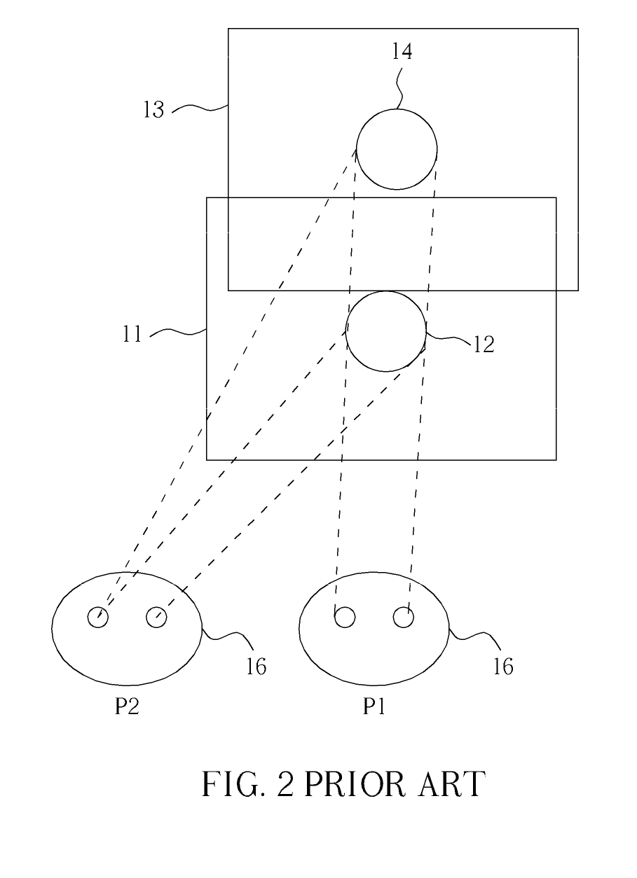

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . .”

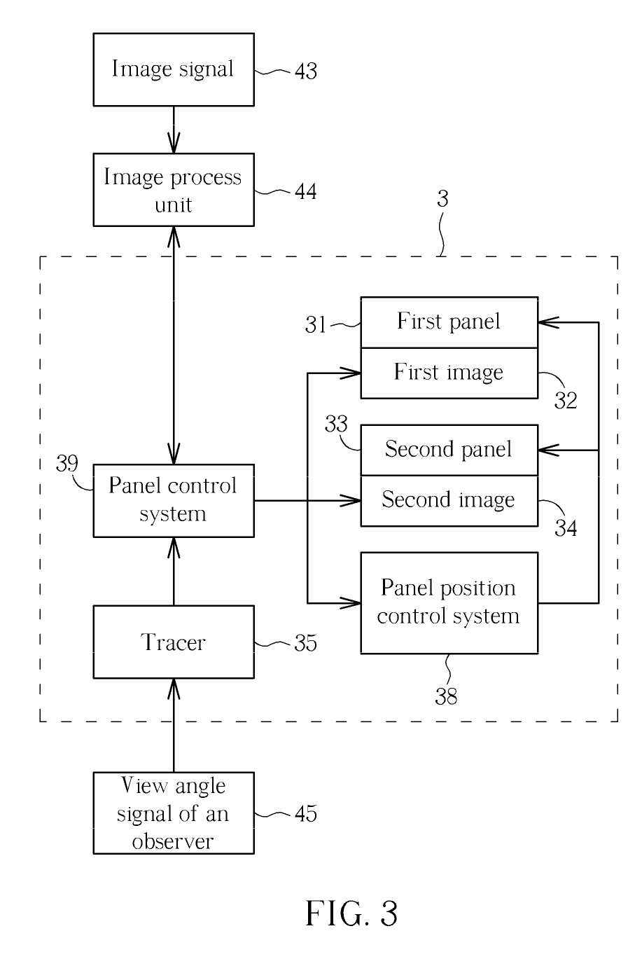

Please refer to FIG. 3, illustrating a block diagram of the depth fused display in the present invention. As shown in FIG. 3, the depth fused display 3 in the present invention includes a first panel 31, a second panel 33, a panel control system 39, a panel position control system 38 and a tracer 35. The panel control system 39 is electrically connected to the first panel 31 and the second panel 33 and is able to control the first panel 31 and the second panel 33 to display a first image 32 and a second image 34 respectively. In addition, the display control system 39 can control the first panel 31 and the second panel 33 relatively via the panel position control system 38, to move in a parallel direction or in a vertical direction, that is, to relatively move the first panel 31 and the second panel 33 while maintaining a vertical relative distance between the first panel 31 and the second panel 33, or to move forward or backward the first panel 31 and/or the second panel 33 to change a vertical relative distance between the first panel 31 and the second panel 33.

Besides, the panel control system 39 can further externally connect to an image process unit 44. The image process unit 44 can receive and process an image signal 43 to be displayed, and then transfer the image signal 43 to the panel control system 39. The panel control system 39 thereby transfers the image signal 43 to the first panel 31 and the second panel 33, allowing the first panel 31 and the second panel 33 to display the first image 32 and the second image 34 respectively.

The depth fused display 3 further includes a tracer 35 that can detect a view angle signal of the observer 45 and transfer the view angle signal of the observer 45 to the panel control system 39. According to the view angle signal of the observer 45, the panel control system 39 can further adjust the first image 32 and the second image 34, or control the relatively position between the first panel 31 and the second panel 33 via the panel position control system 38.

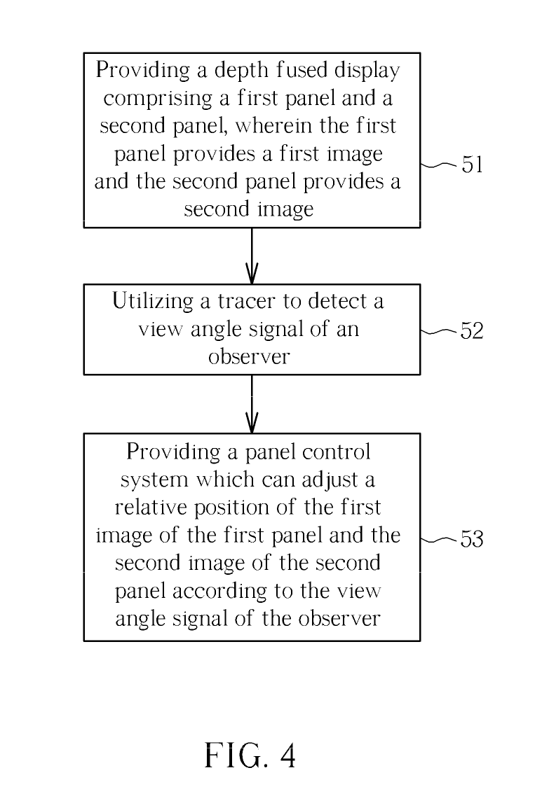

As a result, according to the corresponding relationship between each component in FIG. 3, the present invention provides a method of displaying a depth fused display such that the observer can firmly perceive a depth fused stereoscopic image when the view angle of the observer is changed. Please refer to FIG. 4, illustrating a flow chart diagram of the method of displaying a depth fused display in the present invention. As shown in step 51 of FIG. 4, a depth fused display 3 which includes a first panel 31 and a second panel 33 is provided, wherein the first panel 31 provides a first image 32 and the second panel provides a second image 34. Next in step 52, a tracer 35 is provided to detect a view angle signal of the observer 45. Then in step 53, according to the view angle signal of the observer 45, the panel control system 39 can adjust the relative position of the first image 32 of the first panel 31 and the second image 34 of the second panel 32 such that the observer may perceive a depth fused stereoscopic image superimposed by the first image 32 and the second image 34.

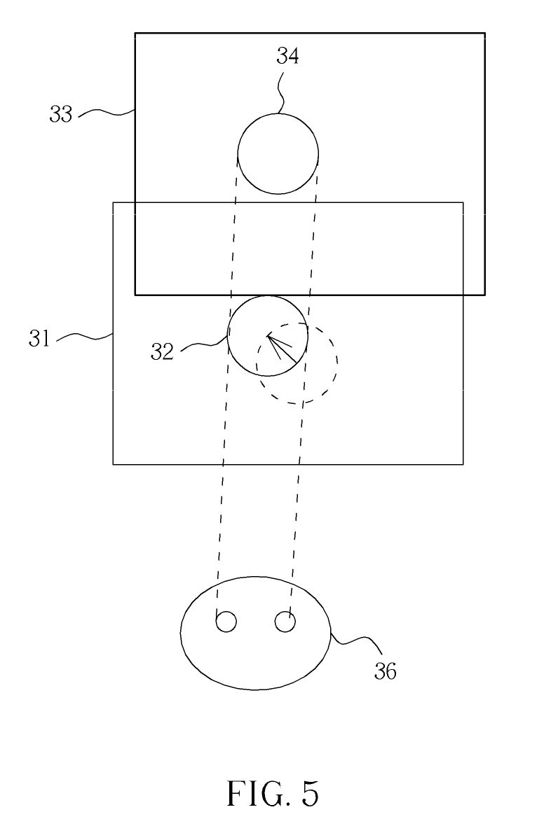

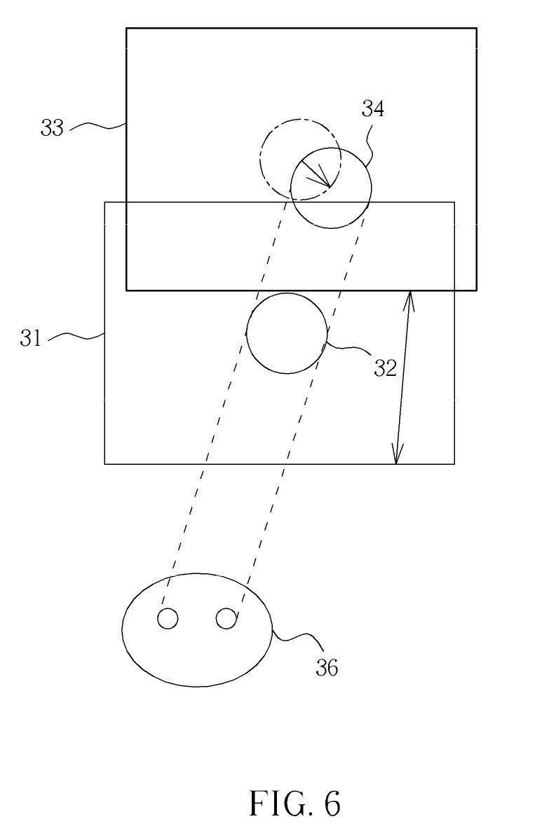

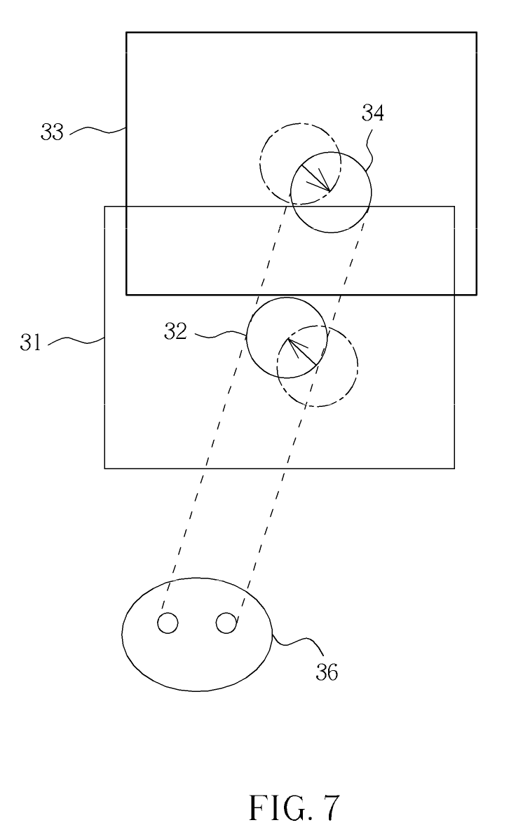

The process of adjusting the relative position of the first image 32 and the second image 34 as described in step 53 may be carried out, for instance, by adjusting the relative position between the first image 32 and the second image 34, or moving the first panel 31 and the second panel 33 via the panel position control system 38. Please refer to FIG. 5 to FIG. 7, illustrating schematic diagrams of adjusting the first image and/or the second image to obtain a superimposed image in the present invention. As shown in FIG. 5, the panel control system 39 can change the display position of the first image 32 according to the view angle signal of the observer 45, rendering the first image 32 move to an appropriate location such that the first image 32 and the second image 34 may be superimposed when viewing from the position of the observer 36 and a fused stereoscopic image is thus obtained. Or as shown in FIG. 6, the panel control system 39 can also change the display position of the second image 34, or in FIG. 7, the panel control system 39 can simultaneously change the display position of the first image 32 and the second image 34. All three abovementioned embodiments may allow the observer 36 to obtain a depth fused stereoscopic image.

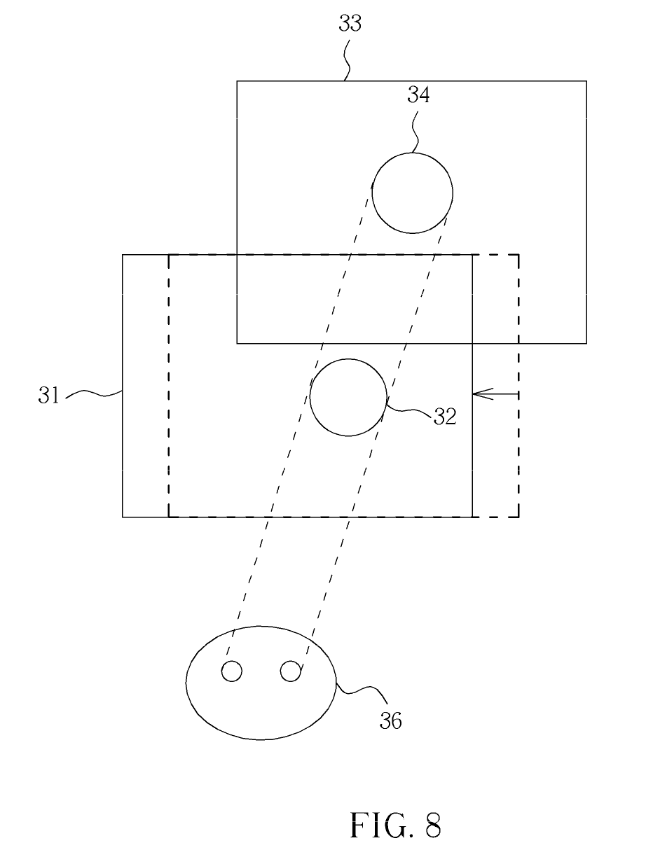

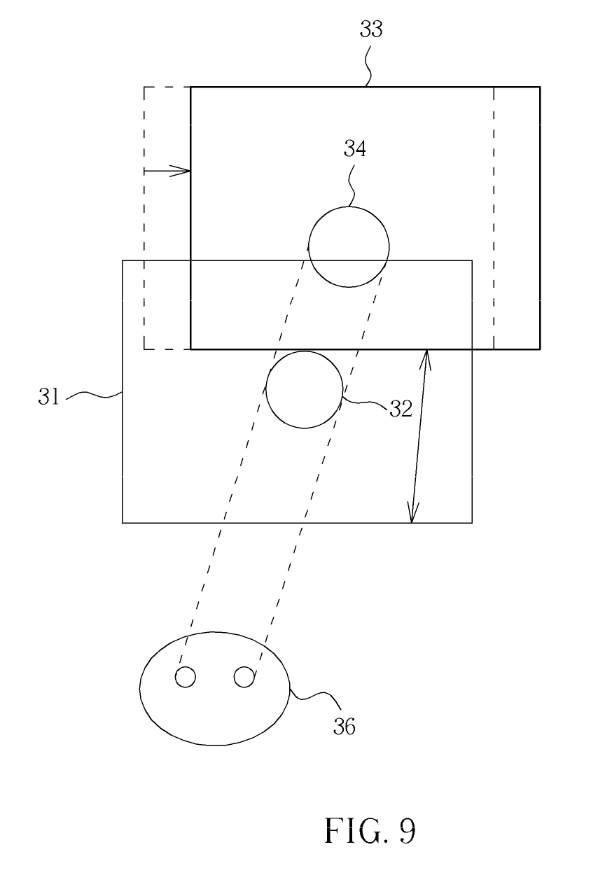

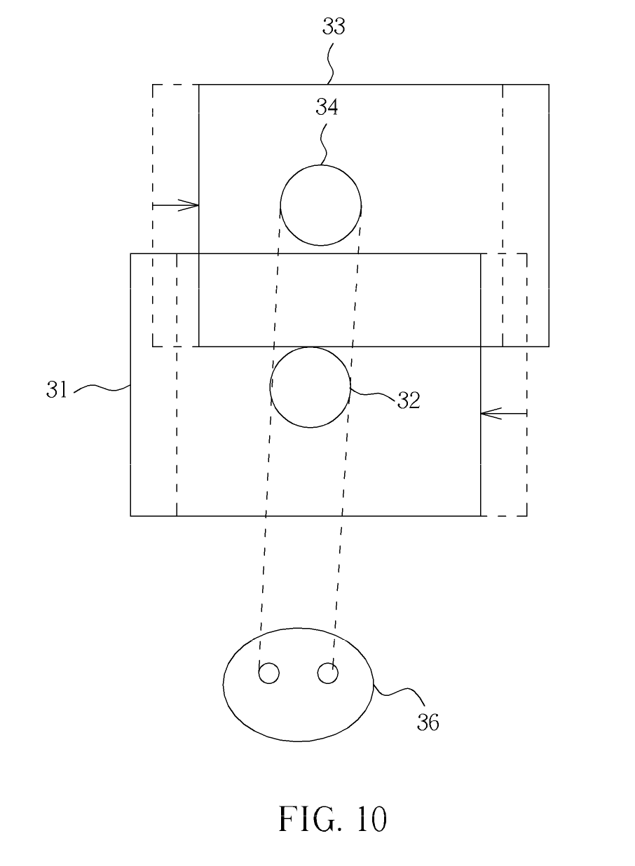

Please refer to FIG. 8 to FIG. 10, illustrating schematic diagrams of adjusting the first panel and/or the second panel to obtain a fused stereoscopic image while maintaining a vertical distance between the first panel and the second panel. As shown in FIG. 8, in order to obtain a fused stereoscopic image for the observer 36, the panel control system 39 can, according to the view angle signal of the observer 45, move the first panel 31 in a parallel direction with respect to the second panel 33 to an appropriate location via the panel position control system 38, such that the first image 32 and the second image 34 may be superimposed when viewing from the position of the observer 36 and a fused stereoscopic image is thus obtained. Or as shown in FIG. 9, the panel control system 39 can move the second panel 33 to an appropriate location in a direction parallel to the first panel 31, or in FIG. 10, the panel control system 39 can simultaneously move the first panel 31 and the second panel 33 while maintaining the vertical distance between the first panel 31 and the second panel 33. All three abovementioned embodiments may allow the observer 36 to obtain a depth fused stereoscopic image.

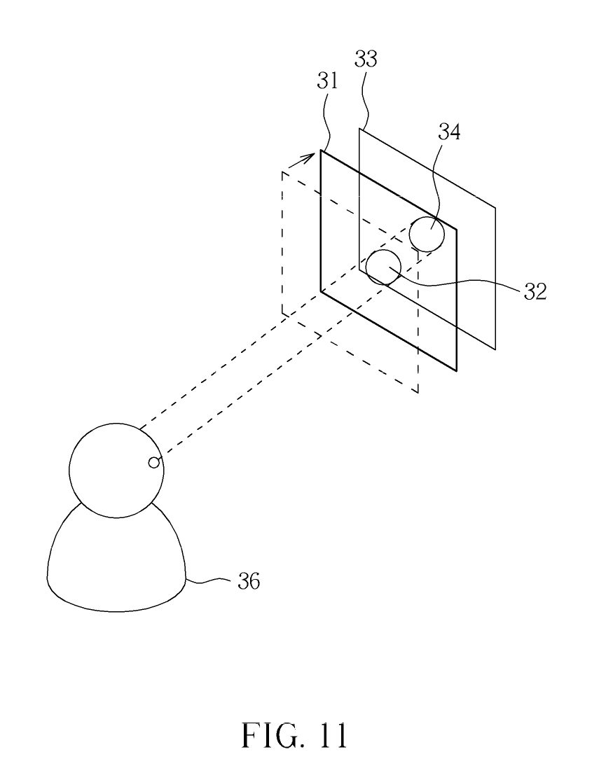

Please refer to FIG. 11, illustrating a schematic diagram of adjusting a vertical distance between the first panel and the second panel to obtain a fused stereoscopic image in the present invention. As shown in FIG. 11, according to the view angle signal of the observer 45, the panel control system 39 can move the first panel 31 forward or backward via the panel position control system 38, such that a fused stereoscopic image may be obtained for the observer 36. Similarly, the panel control system 39 can also move the second panel 33 forward or backward, or simultaneously move the first panel 31 and the second panel 33 forward or backward. The same principle is applied and repeated figures are not illustrated for simplification.

Furthermore, the first panel 31 of the depth fused display 3 in the present invention is closer to the observer 36 and may include an electroluminescence display panel (for example, a light-emitting diode (LED) display panel or an organic light-emitting diode (OLED) display panel), a plasma display panel (PDP) or other light-source-free panels that can emit light itself. The second panel 33 is more distant from the observer 36 and may include an electroluminescence display panel, a plasma display panel or other light-source-free panels that can emit light itself. Moreover, the second panel 33 may include an LCD panel as well.

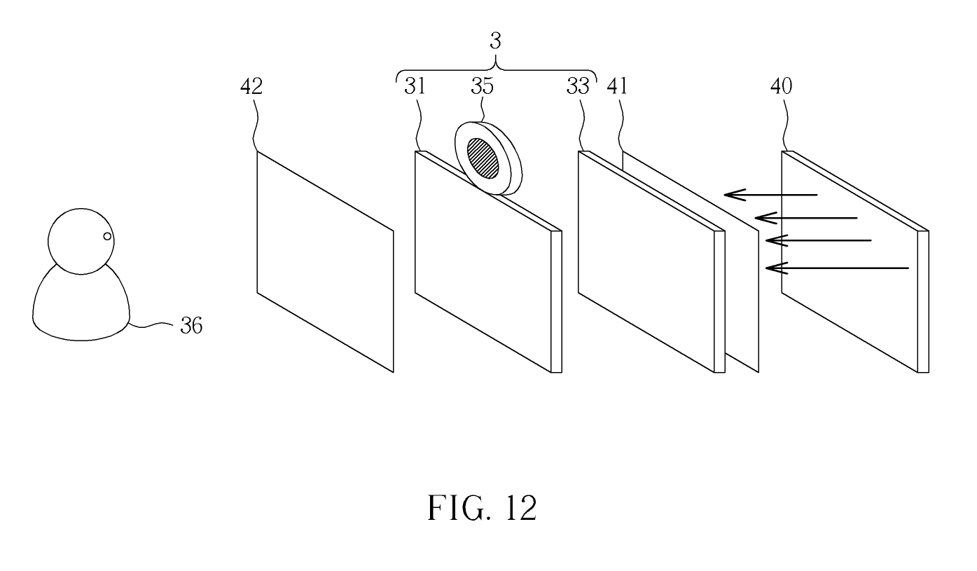

When the first panel 31 and the second panel 33 are both LCD panels, please refer to FIG. 12 that illustrates a schematic diagram of the depth fused display including two LCD panels in the present invention. In FIG. 12, in addition to a backlight module 40 for emitting light, two polarization films 41, 42 are also provided. In conventional arts, an LCD panel usually requires two polarization films. However, in the depth fused display 3 of the present invention, the first panel 31 and the second panel 33 share two polarization films 41, 42 that are disposed individually at two outer sides of the first panel 31 and the second panel 33. As a result, there is no polarization film disposed between the first panel 31 and the second panel 33 in comparison to conventional arts. As a result, the observer 36 in front of the first panel 31 can also obtain a fused stereoscopic image displayed by the two LCD panels.

In addition, as shown in FIG. 12, the tracer 35 in the present invention is disposed upon the first panel 31, but may also be disposed on other places depending on different embodiments. The tracer 35 may include image capture device, infrared ray (IR) device, ultrasonic device, laser device or other suitable device can be used to detect the view angle of an observer.

As a result, the main feature of the method of displaying a depth fused display in the present invention is to detect a view angle signal of an observer, and according to the view angle signal of the observer, the panel control system may adjust the display position of the first image or the second image, or may move the first panel or the second panel left or right, or move the first panel and the second panel forward or backward such that the observer may perceive a fused stereoscopic image. Even if the view angle of the observer is changed, the depth fused display may response immediately to make sure the observer obtain a fused image. It is therefore the conventional feature that the observer fails to obtain a stereoscopic image when obliquely displaying or position changing may be overcome in the present invention, which increases the view freedom for the observer.

Besides, the embodiments described above should not be limited to single operation, but also can be performed in combination with each other. For example, it can be operated by moving the first panel left or right and simultaneously moving the second panel forward or backward, or adjusting the display position of the first image and simultaneously moving the second panel left or right.

Those skilled in the art will readily observe that numerous modifications and alterations of the device and method may be made while retaining the teachings of the invention.

What is claimed is:

1. A method of displaying a depth fused display, comprising:
providing a depth fused display, the depth fused display comprising a first panel and a second panel, wherein the first panel provides a first image and the second panel provides a second image, and wherein the first panel and the second panel are disposed in parallel and opposite to each other;
detecting a view angle signal of an observer; and
adjusting a relative position of the first image of the first panel and the second image of the second panel according to the view angle signal of the observer such that the observer is able to perceive a stereoscopic image.

2. The method of displaying a depth fused display as in claim 1, wherein the step of adjusting the relative position of the first image of the first panel and the second image of the second panel, comprises adjusting a display position of the first image.

3. The method of displaying a depth fused display as in claim 1, wherein the step of adjusting the relative position of the first image of the first panel and the second image of the second panel, comprises adjusting a display position of the second image.

4. The method of displaying a depth fused display as in claim 1, wherein the step of adjusting the relative position of the first image of the first panel and the second image of the second panel, comprises adjusting both a display position of the first image and a display position of the second image.

5. The method of displaying a depth fused display as in claim 1, wherein the step of adjusting the relative position of the first image of the first panel and the second image of the second panel, comprises moving the first panel while maintaining a vertical relative distance between the first panel and the second panel.

6. The method of displaying a depth fused display as in claim 1, wherein the step of adjusting the relative position of the first image of the first panel and the second image of the second panel, comprises moving the second panel while maintaining a vertical relative distance between the first panel and the second panel.

7. The method of displaying a depth fused display as in claim 1, wherein the step of adjusting the relative position of the first image of the first panel and the second image of the second panel, comprises moving both the first panel and the second panel while maintaining a vertical relative distance between the first panel and the second panel.

8. The method of displaying a depth fused display as in claim 1, wherein the step of adjusting the relative position of the first image of the first panel and the second image of the second panel, comprises moving the first panel forward or backward with respect to the second panel to change a vertical relative distance between the first panel and the second panel.

9. The method of displaying a depth fused display as in claim 1, wherein the step of adjusting the relative position of the first image of the first panel and the second image of the second panel, comprises moving the second panel forward or backward with respect to the first panel to change the vertical relative distance between the first panel and the second panel.

10. The method of displaying a depth fused display as in claim 1, wherein the step of adjusting the relative position of the first image of the first panel and the second image of the second panel, comprises moving forward or backward both the first panel and the second panel to change the vertical relative distance between the first panel and the second panel.

11. The method of displaying a depth fused display as in claim 1, wherein the first panel is closer to the observer than the second panel, and the first panel comprises an electroluminescence display panel or a plasma display panel.

12. The method of displaying a depth fused display as in claim 11, wherein the second panel is more distant from the observer than the first panel, and the second panel comprises an electroluminescence display panel, a plasma display panel or a liquid crystal display panel.

13. The method of displaying a depth fused display as in claim 1, wherein both the first panel and the second panel comprise a liquid crystal display panel.

14. The method of displaying a depth fused display as in claim 13, wherein the depth fused display further comprises two polarizing plates disposed on two parallel outer sides of the first panel and the second panel respectively.
